(19) United States
(12) Patent Application Publication
(10) Pub. No.: US 2021/0224861 A1
(43) Pub. Date: Jul. 22, 2021

(54) CREATION OF AND AUTOMATIC RECONFIGURATION OF ADVERTISEMENT TEMPLATE COMPRISING DIGITAL ASSETS FOR UPLOAD TO ONE OR MORE PLATFORMS

(71) Applicant: Alex Merutka, Miami Beach, FL (US)

(72) Inventor: Alex Merutka, Miami Beach, FL (US)

(21) Appl. No.: 17/151,968

(22) Filed: Jan. 19, 2021

Related U.S. Application Data
(60) Provisional application No. 62/963,919, filed on Jan. 21, 2020.

(51) Int. Cl. G06Q 30/02; G06N 5/02

(52) U.S. Cl. CPC G06Q 30/0276; G06N 5/02

(57) ABSTRACT

A computer system configured to implement a method for creation of content comprising digital assets is described. The system receives digital assets selected by a user from an asset library of a database and then generates an advertisement template that comprises the digital assets. Then, the system receives, from the user, an action performed on at least one digital asset to modify the advertisement template. Responsive to updating the advertisement template based on the executed action, the method automatically reconfigures the advertisement template for upload to one or more platforms, where each platform requires a different configuration of the advertisement template.

### CROSS-REFERENCE TO RELATED APPLICATIONS

This application is a U.S. Non-Provisional Patent Application that claims priority to U.S. Provisional Patent Application No. 62/963,919, filed on Jan. 21, 2020, the contents of which are hereby fully incorporated by reference.

### FIELD OF THE EMBODIMENTS

The field of the invention and its embodiments relate to a method to create content comprising digital assets. In particular, the present invention and its embodiments provide a method to generate an advertisement template comprising digital assets, where the advertisement template is automatically reconfigured, via an algorithm, for upload to one or more platforms, where each platform requires a different configuration of the advertisement template.

### BACKGROUND OF THE EMBODIMENTS

Creation of digital content for advertisements involves the combination and/or organization of digital assets. Examples of these digital assets include: textual assets, video assets, audio assets, image assets, and/or animated assets. As with most products, the user may wish to generate enhanced sales of the product and may attempt to do this by pushing or showcasing the advertisement on multiple platforms to promote the product or service. However, as each platform has different requirements for the advertisement, the user must modify the configuration of the advertisement for each platform the user wishes to push or showcase the advertisement on. For example, the user may wish to push the advertisement to the following three platforms: Pinterest, Snapchat, and Facebook. To do so, the user must modify the configuration of the advertisement three times to comply with the unique requirements of each platform. This constant modification becomes extremely time-consuming and expensive for the user. No current solution provides a remedy to this issue. Thus, a need exists for a method to create an advertisement template that a user does not have to consistently modify and that may be automatically reconfigured and pushed to multiple platforms.

### Review of Related Technology:

CN 108428159 A describes a method and system for conveniently and quickly creating advertisements based on a template. The method includes: obtaining template information and material information; editing and matching the template information and the material information; and generating and exporting creative pictures.

CN 108550060 A describes a method to quickly generate varying sized advertisements. The process steps of this method include: obtaining material and template information; matching material and template information; generating a preview graph; and converting the preview graph into advertising images for export.

CN 110210899 A describes an advertisement pushing method based on advertisement similarity.

U.S. Published Patent Application No. 2019/0130356 A1 describes a service provider system, such as a creative service provider system, that supports the creation of digital content in connection with digital content creation projects by employing creative brief schema.

WO 2013/072691 A3 describes a digital content creation platform. The digital content creation platform includes functionality to generate a template from a current layout or convert the current layout to a different template layout.

WO 2016/205614 A1 describes systems, devices, methods and processes for automatically transporting data from a content creation application to a game engine.

Various methods to create digital content for advertisements are known in the art. However, their means of operation are substantially different from the present disclosure, as the other inventions fail to solve all the problems taught by the present disclosure. The present invention and its embodiments provide a method to create content comprising digital assets. In particular, the present invention and its embodiments provide a method to generate an advertisement template comprising digital assets, where the advertisement template is automatically reconfigured, via an algorithm, for upload to one or more platforms, where each platform requires a different configuration of the advertisement template.

### SUMMARY OF THE EMBODIMENTS

The present invention and its embodiments provide a method to create content comprising digital assets. In particular, the present invention and its embodiments provide a method to generate an advertisement template comprising digital assets, where the advertisement template is automatically reconfigured, via an algorithm, for upload to one or more platforms, where each platform requires a different configuration of the advertisement template.

A first embodiment of the instant invention describes a method executed by a creation engine of a computing device for creation of content comprising a first set of digital assets. Each digital asset of the first set of digital assets includes an image asset, an audio asset, an animated asset, a video asset, or a textual asset. The method includes first receiving, from a user, the first set of digital assets selected by the user from an asset library of a database and then generating a first template comprising the first set of digital assets. The first template may be of a first size having a first width and a first height.

Next, the method includes receiving, from the user, an action to modify at least one digital asset of the first set of digital assets. The action to modify the at least one digital asset of the first set of digital assets includes: a modification action, an addition action, a deletion action, a resize action, a re-order action, a re-layer action, and/or a reposition action. Next, the method includes updating the first template based on the executed action. Then, the method includes automatically reconfiguring, via an algorithm, the first template for upload to one or more platforms. The algorithm may include an artificial intelligence (AI) algorithm or an AI computer vision algorithm.

In other examples, the method may further include: receiving, from the user, a second set of digital assets selected by the user from the asset library and generating a second template comprising the second set of digital assets. The second template may be of a second size having a second height and a second width, where the first size of the first template is larger than the second size of the second template. Next, the method may further include: receiving, from the user, a resize action on the first template to increase the first size of the first template to a third size. In response to this action, the method may include automatically resizing the second template to the third size. In some examples, the first template and/or the second template may be advertisement templates. In examples, the advertisement template may be a static advertisement template, an interactive advertisement template, or a video advertisement template.

A second embodiment of the instant invention describes a computer system. The computer system comprises one or more processors, one or more memories, and one or more computer-readable hardware storage devices. The one or more computer-readable hardware storage devices contain program code executable by the one or more processors via the one or more memories to implement a method for creation of content comprising a first set of digital assets. The method includes first receiving, from a user, the first set of digital assets selected by the user from an asset library of a database and then generating a first advertisement template comprising the first set of digital assets. The first advertisement template may be of a first size having a first width and a first height. Next, the method includes receiving, from the user, an action to modify at least one digital asset of the first set of digital assets and updating the first advertisement template based on the executed action. Then, the method includes automatically reconfiguring, via an algorithm and in real-time, the first advertisement template for upload to one or more platforms. Each of the one or more platforms requires a different configuration of the first advertisement template.

In examples, the method may further include: receiving, from the user, a second set of digital assets uploaded by the user and then generating a second advertisement template comprising the second set of digital assets. The second advertisement template may have a second size comprising a second width and a second height. It should be appreciated that the first size of the first advertisement template differs from the second size of the second advertisement template. Next, the method may include receiving, from the user, a resize action on the first advertisement template to increase the first size of the first advertisement template to a third size. In response to this, the method may include automatically resizing the second advertisement template to the third size.

A third embodiment of the instant invention describes a method executed by a creation application of a computing device for creation of content comprising digital assets. The method includes receiving, from a user, the first set of digital assets selected by the user from an asset library of a database and a second set of digital assets uploaded by the user. Each digital asset of the first and the second set of digital assets are selected from the group consisting of: an image asset, an animated asset, an audio asset, a video asset, and a textual asset.

Then, the method includes generating a first advertisement template comprising the first set of digital assets and the second set of digital assets. The first advertisement template may be a static advertisement template, an interactive advertisement template, or a video advertisement template. The method then includes receiving, from the user, an action to modify at least one digital asset of the first set of digital assets and/or the second set of digital assets. The action may include: a modification action, an addition action, a deletion action, a resize action, a re-order action, a re-layer action, and/or a reposition action, among other actions not explicitly listed herein. In response to this, the first advertisement template is updated based on the executed action and then the first advertisement template is automatically reconfigured, via an algorithm, for upload to one or more platforms, where each of the one or more platforms requires a different configuration of the first advertisement template. The algorithm may be an AI algorithm or an AI computer vision algorithm.

In general, the present invention succeeds in conferring the following benefits and objectives.

It is an object of the present invention to provide a method executed by a creation engine of a computing device for creation of content comprising digital assets. It is an object of the present invention to provide a method executed by a creation application of a computing device for creation of content comprising digital assets.

It is an object of the present invention to provide a method executed by a creation software program of a computing device for creation of content comprising digital assets.

It is an object of the present invention to provide a method executed by a creation service of a computing device for creation of content comprising digital assets.

It is an object of the present invention to provide a method executed by a creation software platform of a computing device for creation of content comprising digital assets.

It is an object of the present invention to provide a method executed by a creation engine of a computing device for creation of an advertisement template comprising digital assets.

It is an object of the present invention to provide a method executed by a creation engine of a computing device for creation of multiple permeations or iterations of an advertisement template comprising digital assets for upload to one or more platforms.

It is an object of the present invention to provide a method executed by a creation engine of a computing device for automatically reconfiguring, via an algorithm, an advertisement template for upload to one or more platforms, where the one or more platforms require different configurations of the advertisement template.

It is an object of the present invention to provide a method executed by a creation engine of a computing device for automatically reconfiguring, via an AI algorithm, an advertisement template for upload to one or more platforms, where the one or more platforms require different configurations of the advertisement template.

It is an object of the present invention to provide a method executed by a creation engine of a computing device for automatically reconfiguring, via an AI computer vision algorithm, an advertisement template for upload to one or more platforms, where the one or more platforms require different configurations of the advertisement template.

### BRIEF DESCRIPTION OF THE DRAWINGS

FIG. 1 depicts a perspective view of a computer system configured to create content comprising digital assets, according to at least some embodiments described herein.

FIG. 2 depicts another perspective view of a computer system configured to create content comprising digital assets, according to at least some embodiments described herein.

FIG. 3A depicts a perspective view of an advertisement template builder configured to build or generate a first configuration of an advertisement template, according to at least some embodiments described herein.

FIG. 3B depicts a perspective view of a first configuration of an advertisement template, according to at least some embodiments described herein.

FIG. 3C depicts a perspective view of a second configuration of an advertisement template, according to at least some embodiments described herein.

FIG. 4 is a block diagram of a computing device included within the computer system of FIG. 1 that is configured to create content comprising digital assets, in accordance with embodiments of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

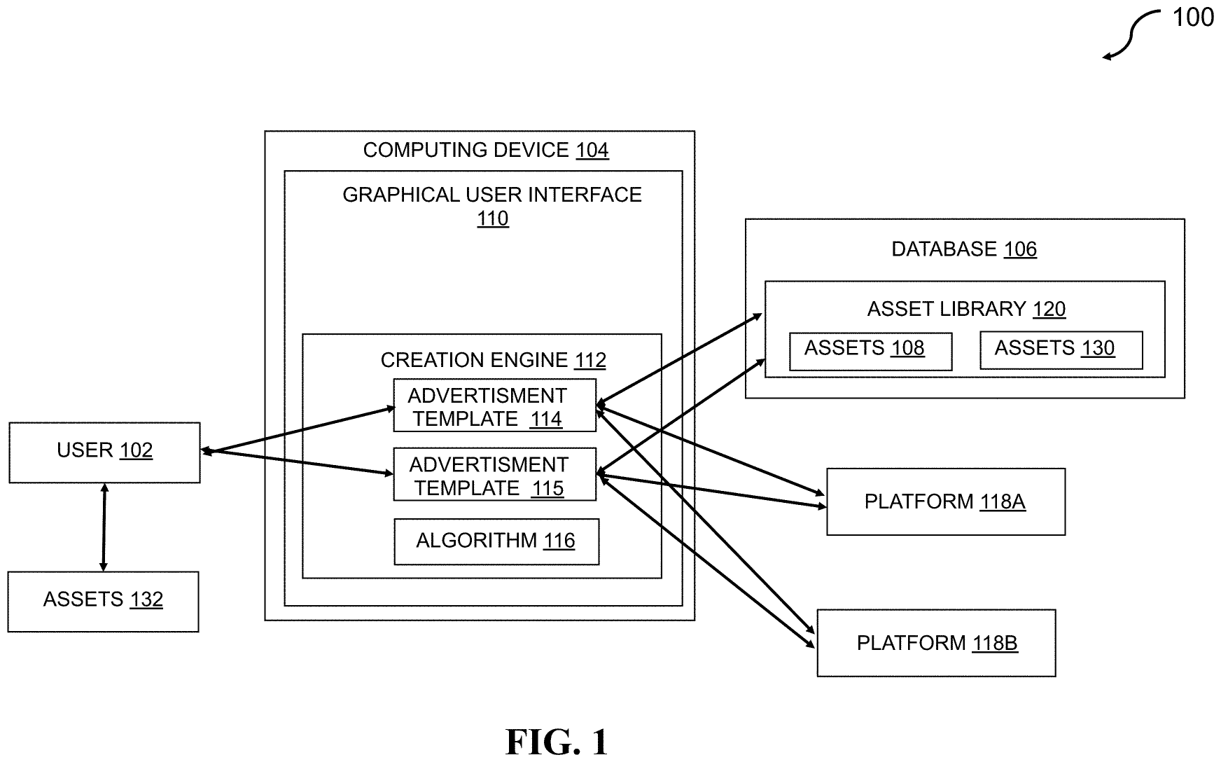

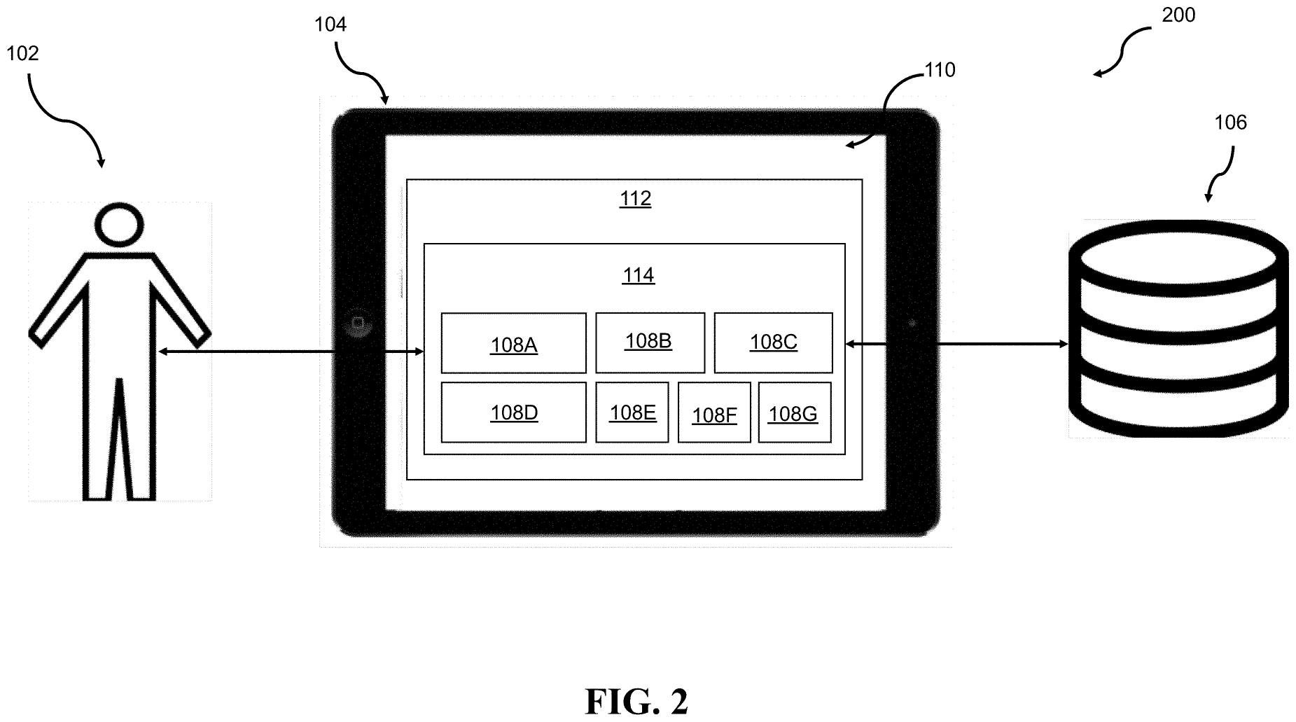

FIG. 1 and FIG. 2 depict a perspective view of a computer system configured to create content comprising digital assets, according to at least some embodiments described herein.

A computer system 100 and a computer system 200, of FIG. 1 and FIG. 2 respectively, includes a computing device 104. The computing device 104 may be a computer, a laptop computer, a smartphone, and/or a tablet, among other examples not explicitly listed herein. The computing device 104 may comprise a creation engine 112 that may execute a method to create content comprising a first set of digital assets 108 and/or a second set of digital assets 130. In other examples, the creation engine 112 may be a creation application, a creation software program, a creation service, or a creation software platform configured to be executable on the computing device 104. A user 102 may interact directly with the creation engine 112 via a graphical user interface (GUI) 110 of the computing device 104.

The creation engine 112 may receive, from a user 102, the first set of digital assets 108 selected by the user 102 from an asset library 120 of a database 106. Each asset of the first set of digital assets 108 may include multimedia content, such as text, tables, computer executable code, images, slideshows, audio, video, and/or links, etc. In some examples, each asset of the first set of digital assets 108 may include an image asset, an audio asset, an animated asset, a video asset, or a textual asset.

Then, the creation engine 112 may generate a first template 114 comprising the first set of digital assets 108. As depicted in FIG. 2, the first set of digital assets 108 may comprise a first asset 108A, a second asset 108B, a third asset 108C, a fourth asset 108D, a fifth asset 108E, a sixth asset 108F, and a seventh asset 108G, among others not explicitly listed or depicted herein. In some examples, the first template 114 may be an advertisement template. In examples, the advertisement template may be a static advertisement template, an interactive advertisement template, or a video advertisement template.

Next, the creation engine 112 may receive, from the user 102, an action to modify at least one digital asset of the first set of digital assets 108. The action may include: a modification action (e.g., moving the asset, scaling the asset, masking the asset, editing a color of the textual asset, a font size of the textual asset, a size of the digital asset, a grayscale of an image asset, etc.), an addition action (e.g., adding text to the textual asset, adding a font to the image asset, etc.), a deletion action (e.g., removing a portion of text from the textual asset, removing the image asset from the first template 114, etc.), a resize action (e.g., resizing a height of a digital asset, resizing a width of a digital asset, etc.), a re-order or a re-layer action (e.g., moving the textual asset to a position in front of the image asset), and/or a reposition action (e.g., moving the textual asset from a first location to a second location), among other actions not explicitly listed herein. In response to receiving this action, the creation engine 112 may update the first template 114 based on the executed action. In some examples, the user 102 may then save the first template 114 to a library, such as a project library, on the computing device 102.

Next, the creation engine 112 may automatically reconfigure the first template 114 for upload to one or more platforms. As an illustrative example of this reconfiguration, the creation engine 112 may assess each of the one or more platforms and identify the specific requirements for each of the one or more platforms. Examples of these specific requirements may include: a file structure and/or a platform-specific application programming interface (API) that allows the given asset to communicate with the target platform. Responsive to this assessment, the creation engine 112 may enable or disable features, based on what is allowed for each of the one or more platforms. Examples of such features that may be enabled or disabled include: audio sounds and/or third-party calls. Then, the creation engine 112 produces or generates a final version of the first template 114 with the features enabled or disabled.

In examples, the automatic reconfiguration of the first template 114 may occur via an algorithm 116. In some examples, the algorithm 116 may include an artificial intelligence (AI) algorithm or an AI computer vision algorithm, among other algorithms not explicitly listed herein. Essentially, the algorithm 116 may create multiple combinations or permutations (e.g., layouts) of the first template 114 quickly and easily, saving the user 102 a substantial amount of time and money. Without the ability to create multiple combinations or permutations (e.g., the layouts) of the first template 114 quickly and easily, the user 102 would have to manually do this for each platform the user 102 wishes to upload the first template 114 to.

Next, the creation engine 112 may automatically upload the first template 114 to the one or more platforms. The one or more platforms may include a first platform 118A and/or a second platform 118B, among other platforms not explicitly listed herein or depicted herein. In other examples, the upload of the first template 114 to one or more platforms occurs in real-time, where each platform of the one or more platforms requires a different configuration of the first template 114. For example, the first platform 118A requires a first configuration of the first template 114 and the second platform 118B requires a second configuration of the second template 118B, where the first configuration is disparate from the second configuration. For example, the first platform 118A may require specific dimensions of the first template 114 not required by the second platform 118B.

In other embodiments of the instant invention, the creation engine 112 may also receive, from the user 102, a second set of digital assets 130 selected by the user 102 from the asset library 120. Each asset of the second set of digital assets 130 may include multimedia content, such as text, tables, computer executable code, images, slideshows, audio, video, and/or links, etc. In some examples, each asset of the second set of digital assets 130 may include an image asset, an animated asset, an audio asset, a video asset, or a textual asset. In response to receiving the second set of digital assets 130, the creation engine 112 may generate a second template 115 comprising the second set of digital assets 130.

According to examples, the first template 114 is of a first size (e.g., a first height and a first width) and the second template 115 is of a second size (e.g., a second height and a second width), such that the first size is larger than the second size. Then, the creation engine 112 may also receive, from the user 102, a resize action on the first template 114 to increase the first size of the first template 114 to a third size. In response to this action, the creation engine 112 may automatically resize the second template 115 to the third size. The automatic resizing saves the user 102 time, as this action is typically performed manually by the user 102.

In an additional embodiment of the instant invention, the creation engine 112 may receive, from the user 102, a third set of digital assets 132 uploaded by the user 102 from a source other than the database 106. Each asset of the third set of digital assets 132 may include an image asset, an animated asset, an audio asset, a video asset, or a textual asset. Then, the creation engine 112 may then generate the second template 115 comprising the third set of digital assets 132. The first template 114 may be of a first size comprising a first width and a first height. The second template 115 may be of a second size comprising a second width and a second height. The first size differs from the second size. Next, the creation engine 112 may receive, from the user 102, a resize action on the first template 114 to increase the first size of the first template 114 to a third size. In response, the creation engine 112 may automatically resize the second template 115 to the third size.

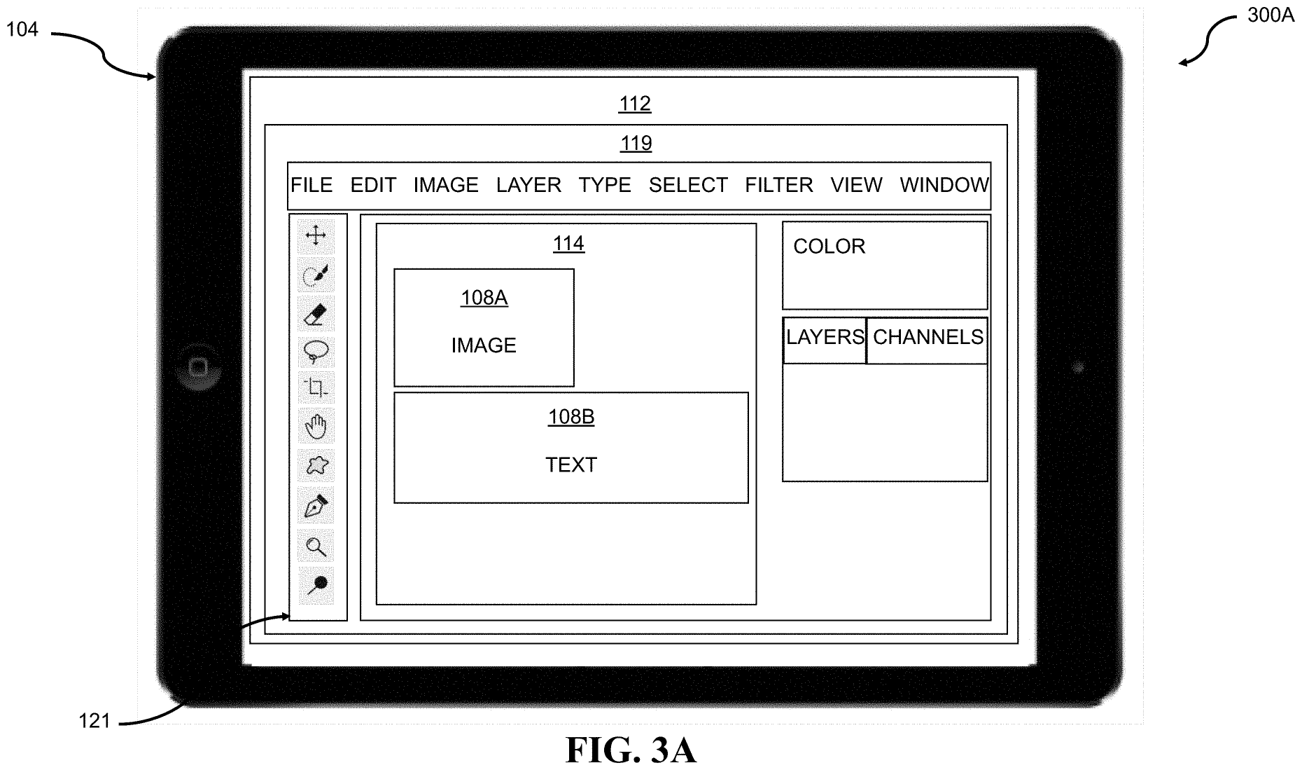

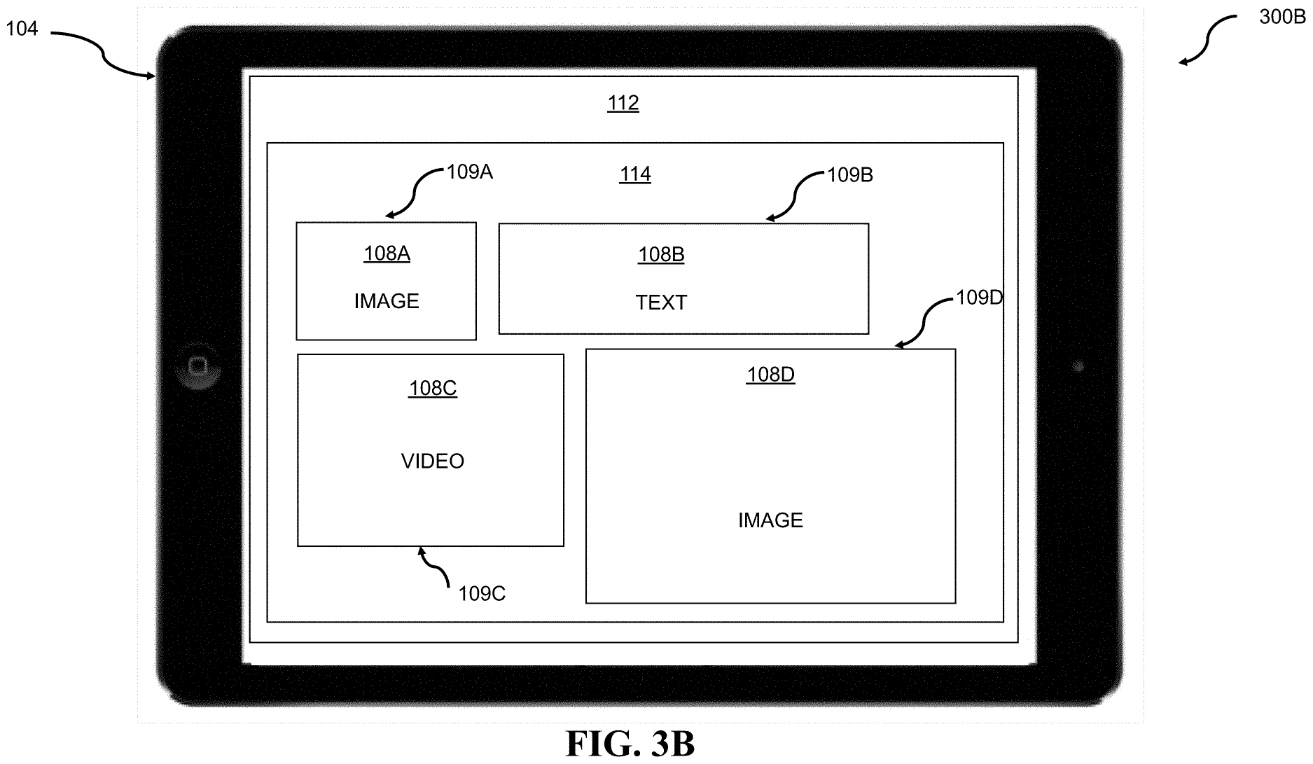

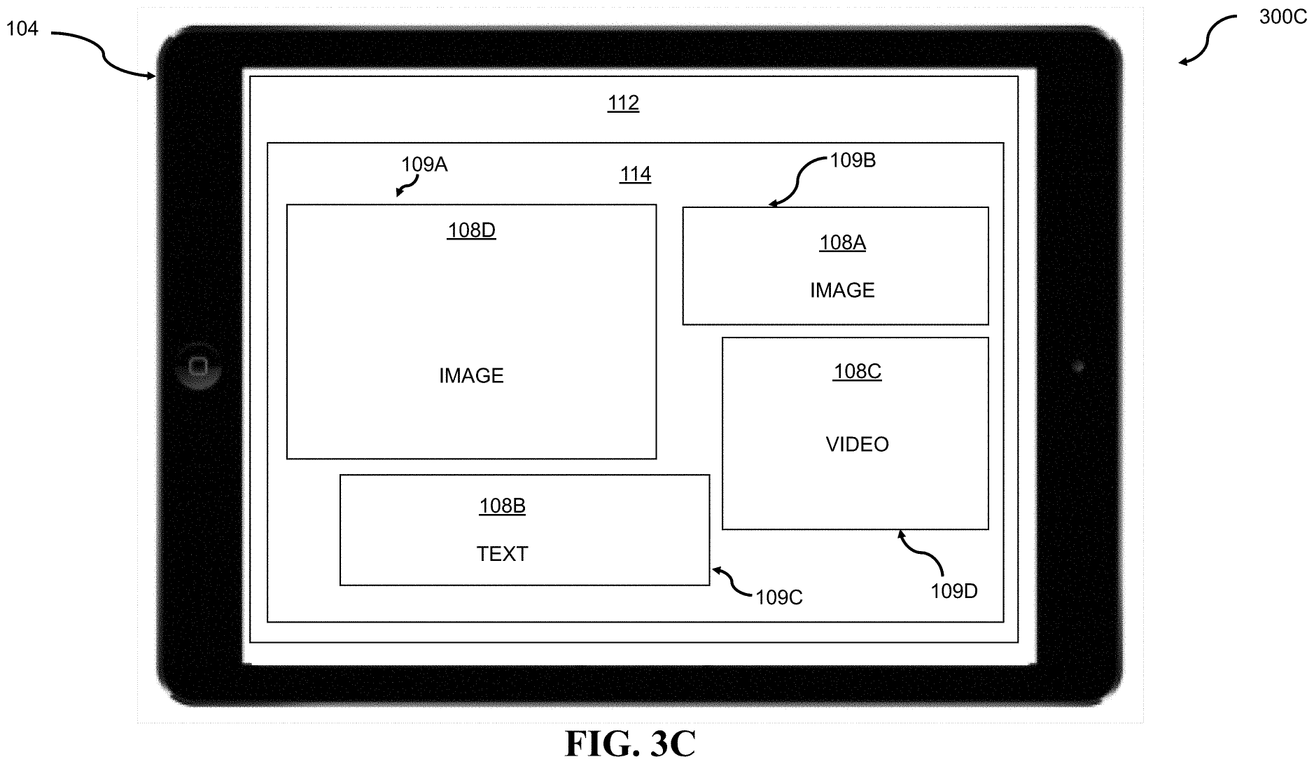

FIG. 3A depicts a perspective view of an advertisement template builder configured to build or generate a first configuration of an advertisement template, according to at least some embodiments described herein.

As shown in FIG. 3A, the user 102 may interact with an advertisement template builder 119 of the creation engine 112 in multiple ways. According to a first example, the user 102 may upload an advertisement template (such as the first template 114) from another platform and then utilize tools from a design toolbar 121 to modify one or more assets of the first template 114. According to a second example, the user 102 may first select one or more assets (such as the first set of digital assets 108) from the asset library 120 of the database 106 and then build the first template 114 using the tools from the design toolbar 121. In other examples, the user 102 may utilize an existing or default template present within the advertisement template builder 119.

FIG. 3B depicts a perspective view of a first configuration of an advertisement template, according to at least some embodiments described herein. FIG. 3C depicts a perspective view of a second configuration of an advertisement template, according to at least some embodiments described herein.

As shown in FIG. 3B, the first template 114 is an advertisement template of a first configuration. The first template 114 may comprise a first asset 108A, a second asset 108B, a third asset 108C, and a fourth asset 108D. As depicted in FIG. 3B, the first configuration of the first template 114 includes: the first asset 108A being an image asset located in a first position 109A, the second asset 108B being a textual asset located in a second position 109B, the third asset 108C being a video asset located in a third position 109C, and the fourth asset 108D being an image asset located in a fourth position 109D.

As explained supra, the creation engine 112 may receive, from the user 102, an action to modify at least one digital asset of the first set of digital assets 108 in the first template 114. The action may include: a modification action (e.g., editing a color of the textual asset, a font size of the textual asset, a size of the digital asset, a grayscale of an image asset, etc.), an addition action (e.g., adding text to the textual asset, adding a font to the image asset, etc.), a deletion action (e.g., removing a portion of text from the textual asset, removing the image asset from the first template 114, etc.), a resize action (e.g., resizing a height of a digital asset, resizing a width of a digital asset, etc.), a re-order or a re-layer action (e.g., moving the textual asset to a position in front of the image asset), and/or a reposition action (e.g., moving the textual asset from a first location to a second location), among other actions not explicitly listed herein.

As an illustrative example, the action may include: moving the first asset 108A from the first position 109A to the second position 109B, resizing the first asset 108A from a first size to a second size where the second size is larger than the first size, moving the second asset 108B from the second position 109B to the third position 109C, moving the third asset 108B from the third position 109C to the fourth position 109D, and/or moving the fourth asset 108D from the fourth position 109D to the first position 109A, among other actions not explicitly listed herein. These actions transform the first configuration of the first template 114 to a second configuration, as depicted in FIG. 3C.

In other embodiments contemplated by the instant invention, the method executed by the creation engine 112 of the computing device 104 may include: receiving, by the creation engine 112, the first template 114 from another software program or application. This other software program or application may be housed on the computing device 104. In some examples, this other software program may be Adobe® Photoshop® or Illustrator® . In response to receiving the first template 114, the user 102 may add or attach smart objects and/or linked smart objects to the first template 114. As defined herein, the smart objects are layers that contain image data from raster or vector images, such as Adobe® Photoshop® or Illustrator® files. The smart objects preserve an image's source content with all its original characteristics, enabling the user 102 to perform non-destructive editing to the layer. Then, the algorithm 116 of the creation engine 112 may automatically re-assemble the first template 114 with the attached smart objects. The updated first template 114 may then be automatically uploaded or pushed to the one or more platforms.

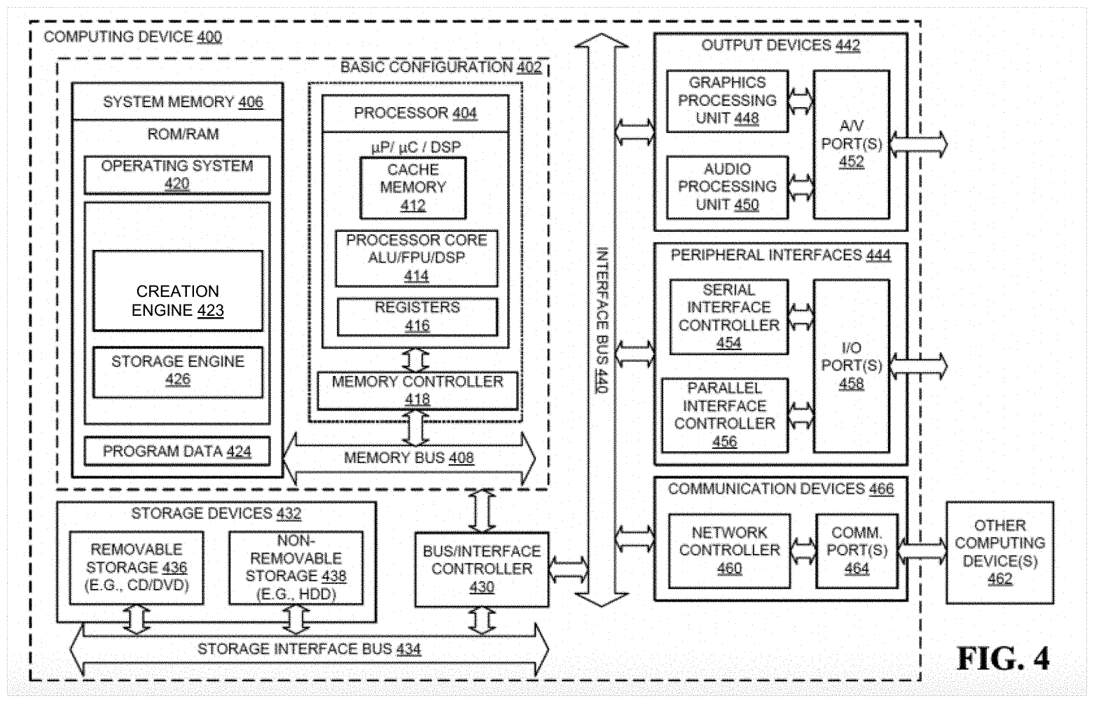

FIG. 4 is a block diagram of a computing device included within the computer system of FIG. 1 that is configured to create content comprising digital assets, in accordance with embodiments of the present invention.

In some embodiments, the present invention may be a computer system, a method, and/or a computing device 104 (of FIG. 1) or 400 (of FIG. 4). For example, the computer system and/or the computing device 400 may be utilized to implement a method for creation of content comprising digital assets.

A basic configuration 402 of a computing device 400 is illustrated in FIG. 4 by those components within the inner dashed line. In the basic configuration 402 of the computing device 400, the computing device 400 includes a processor 404 and a system memory 406. In some examples, the computing device 400 may include one or more processors and the system memory 406. A memory bus 408 is used for communicating between the one or more processors 404 and the system memory 406.

Depending on the desired configuration, the processor 404 may be of any type, including, but not limited to, a microprocessor (μP), a microcontroller (μC), and a digital signal processor (DSP), or any combination thereof. Further, the processor 404 may include one more levels of caching, such as a level cache memory 412, a processor core 414, and registers 416, among other examples. The processor core 414 may include an arithmetic logic unit (ALU), a floating point unit (FPU), and/or a digital signal processing core (DSP Core), or any combination thereof. A memory controller 418 may be used with the processor 404, or, in some implementations, the memory controller 418 may be an internal part of the memory controller 404.

Depending on the desired configuration, the system memory 406 may be of any type, including, but not limited to, volatile memory (such as RAM), and/or non-volatile memory (such as ROM, flash memory, etc.), or any combination thereof. The system memory 406 includes an operating system 420, one or more engines, such as a creation engine 423, and program data 424. In some embodiments, the creation engine 423 may be a creation application, a creation software program, a creation service, or a creation software platform. Moreover, in additional examples, the creation engine 423 may comprise the algorithm 116, such as an artificial intelligence (AI) algorithm or an AI computer vision algorithm, among other algorithms not explicitly listed herein.

The creation engine 423 may receive, from the user 102, the first set of digital assets 108 and the second set of digital assets 130 selected by the user 102 from the asset library 120 of the database 106. Then, the creation engine 423 may receive, from the user 102, the third set of digital assets 132 uploaded by the user 102 from another source other than the database 106. Next, the creation engine 423 may generate the first template 114 (e.g., an advertisement template) comprising the first set of digital assets 108, the second set of digital assets 130, and the third set of digital assets 132. After the creation engine 423 receives, from the user 102, one or more actions performed on at least one digital asset of the first set of digital assets 108, the second set of digital assets 130, and/or the third set of digital assets 132 to modify the first template 114, the creation engine 423 may automatically reconfigure, via the algorithm 116, the first template 114 for upload to one or more platforms. Each of the one or more platforms requires a different configuration of the first template 114. Further, the computing device 400 may comprise a storage engine 426, which may be configured to store information, such as the first set of digital assets 108, the second set of digital assets 130, the third set of digital assets 132, and/or the first template 114, among other data not explicitly listed herein.

Moreover, the computing device 400 may have additional features or functionality, and additional interfaces to facilitate communications between the basic configuration 402 and any desired devices and interfaces. For example, a bus/interface controller 430 is used to facilitate communications between the basic configuration 402 and data storage devices 432 via a storage interface bus 434. The data storage devices 432 may be one or more removable storage devices 436, one or more non-removable storage devices 438, or a combination thereof. Examples of the one or more removable storage devices 436 and the one or more non-removable storage devices 438 include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus 440 facilitates communication from various interface devices (e.g., one or more output devices 442, one or more peripheral interfaces 444, and one or more communication devices 466) to the basic configuration 402 via the bus/interface controller 430. Some of the one or more output devices 442 include a graphics processing unit 448 and an audio processing unit 450, which are configured to communicate to various external devices, such as a display or speakers, via one or more A/V ports 452. The one or more peripheral interfaces 444 may include a serial interface controller 454 or a parallel interface controller 456, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 458. Further, the one or more communication devices 466 may include a network controller 460, which is arranged to facilitate communication with one or more other computing devices 462 over a network communication link via one or more communication ports 464. The one or more other computing devices 462 include servers, the database 106, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 406, the one or more removable storage devices 436, and the one or more non-removable storage devices 438 are examples of the computer-readable storage media. The computer-readable storage media is a tangible device that can retain and store instructions (e.g., program code) for use by an instruction execution device (e.g., the computing device 400). Any such, computer storage media is part of the computing device 400.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein regarding illustrations and/or block diagrams of methods, computer systems, and computing devices according to embodiments of the invention. It will be understood that each block in the block diagrams, and combinations of the blocks, can be implemented by the computer-readable instructions (e.g., the program code).

The computer-readable instructions are provided to the processor 404 of a general purpose computer, special purpose computer, or other programmable data processing apparatus (e.g., the computing device 400) to produce a machine, such that the instructions, which execute via the processor 404 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 400), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer/computing device, partly on the user's computer/computing device, as a stand-alone software package, partly on the user's computer/computing device and partly on a remote computer/computing device or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions. The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

Another embodiment of the invention provides a method that performs the process steps on a subscription, advertising, and/or fee basis. That is, a service provider can offer to assist in the method steps of creating content comprising digital assets. In this case, the service provider can create, maintain, and/or support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A method executed by a creation engine of a computing device for creation of content comprising a first set of digital assets, the method comprising:
receiving, from a user, the first set of digital assets selected by the user from an asset library of a database;
generating a first template comprising the first set of digital assets;
receiving, from the user, an action to modify at least one digital asset of the first set of digital assets;
updating the first template based on the executed action; and
automatically reconfiguring the first template for upload to one or more platforms.

2. The method of claim 1, wherein each digital asset of the first set of digital assets is selected from the group consisting of: an image asset, an audio asset, an animated asset, a video asset, and a textual asset.

3. The method of claim 1, wherein the action to modify the at least one digital asset of the first set of digital assets is selected from the group consisting of: a modification action, an addition action, a deletion action, a resize action, a re-order action, a re-layer action, and a reposition action.

4. The method of claim 1, wherein the automatically reconfiguring the first template for upload to one or more platforms occurs via an algorithm.

5. The method of claim 4, wherein the algorithm is selected from the group consisting of: an artificial intelligence (AI) algorithm and an AI computer vision algorithm.

6. The method of claim 1, further comprising:
receiving, from the user, a second set of digital assets selected by the user from the asset library; and
generating a second template comprising the second set of digital assets,
wherein the first template is of a first size and the second template is of a second size, and
wherein the first size is larger than the second size.

7. The method of claim 6, further comprising:
receiving, from the user, a resize action on the first template to increase the first size of the first template to a third size; and
automatically resizing the second template to the third size.

8. The method of claim 6, wherein each of the first template and the second template comprise an advertisement template.

9. The method of claim 8, wherein the advertisement template is selected from the group consisting of: a static advertisement template, an interactive advertisement template, and a video advertisement template.

10. A computer system comprising one or more processors, one or more memories, and one or more computer-readable hardware storage devices, the one or more computer-readable hardware storage devices containing program code executable by the one or more processors via the one or more memories to implement a method for creation of content comprising a first set of digital assets, the method comprising:
receiving, from a user, the first set of digital assets selected by the user from an asset library of a database;
generating a first advertisement template comprising the first set of digital assets;
receiving, from the user, an action to modify at least one digital asset of the first set of digital assets;
updating the first advertisement template based on the executed action; and
automatically reconfiguring, via an algorithm, the first advertisement template for upload to one or more platforms.

11. The computer system of claim 10, wherein the automatically reconfiguring, via the algorithm, the first template for upload to the one or more platforms occurs in real-time.

12. The computer system of claim 10, wherein the method further comprises:
receiving, from the user, a second set of digital assets uploaded by the user; and
generating a second advertisement template comprising the second set of digital assets,
wherein the first advertisement template has a first size comprising a first width and a first height,
wherein the second advertisement template has a second size comprising a second width and a second height, and
wherein the first size differs from the second size.

13. The computer system of claim 12, wherein the method further comprises:
receiving, from the user, a resize action on the first advertisement template to increase the first size of the first advertisement template to a third size; and
automatically resizing the second advertisement template to the third size.

14. The computer system of claim 11, wherein each of the one or more platforms requires a different configuration of the first advertisement template.

15. A method executed by a creation application of a computing device for creation of content comprising digital assets, the method comprising:
receiving, from a user, the first set of digital assets selected by the user from an asset library of a database;
receiving, from the user, a second set of digital assets uploaded by the user;
generating a first advertisement template comprising the first set of digital assets and the second set of digital assets;
receiving, from the user, an action to modify at least one digital asset of the first set of digital assets and/or the second set of digital assets;
updating the first advertisement template based on the executed action; and
automatically reconfiguring, via an algorithm, the first advertisement template for upload to one or more platforms, wherein each of the one or more platforms requires a different configuration of the first advertisement template.

16. The method of claim 15, wherein each digital asset of the first set of digital assets and the second set of digital assets is selected from the group consisting of: an image asset, an animated asset, an audio asset, a video asset, and a textual asset.

17. The method of claim 15, wherein the action performed on the at least one digital asset of the first set of digital assets and/or the second set of digital assets is selected from the group consisting of: a modification action, an addition action, a deletion action, a resize action, a re-order action, a re-layer action, and a reposition action.

18. The method of claim 15, wherein the algorithm is an artificial intelligence (AI) algorithm.

19. The method of claim 15, wherein the algorithm is an AI computer vision algorithm.

20. The method of claim 15, wherein the first advertisement template is selected from the group consisting of: a static advertisement template, an interactive advertisement template, and a video advertisement template.
